(19) United States
(12) Patent Application Publication
(10) Pub. No.: US 2021/0367762 A1
(43) Pub. Date: Nov. 25, 2021

(54) OFF-CHAIN DATA SHARING SYSTEM AND METHOD THEREOF

(71) Applicant: SAMSUNG SDS CO., LTD., Seoul (KR)

(72) Inventors: Sang Ji BAE, Seoul (KR); Ji Won KIM, Seoul (KR); Sang Jun KANG, Seoul (KR); Han Saem SEO, Seoul (KR)

(21) Appl. No.: 17/029,522

(22) Filed: Sep. 23, 2020

(30) Foreign Application Priority Data
May 19, 2020 (KR) 10-2020-0059823

(51) Int. Cl. H04L 9/06; H04L 29/06

(52) U.S. Cl. CPC H04L 9/0637; H04L 63/10

(57) ABSTRACT

An off-chain data sharing system according to an embodiment of the present invention includes a first storage node to store off-chain data, a blockchain node to store a ledger that records permission information of the off-chain data, and a data stream hub to relay data transmission and reception between the first storage node and a second storage node requesting the off-chain data by referring to the permission information.

### CROSS-REFERENCE TO RELATED APPLICATIONS

This patent application claims the benefit of Korean Patent Application No. 10-2020-0059823, filed on May 19, 2020, which is hereby incorporated by reference in its entirety into this application.

### 1. FIELD

The present invention relates to a system and method for sharing data between different storage devices. More specifically, it relates to data sharing whose history is managed through a blockchain. Since the history of registration and sharing of the data is managed through the blockchain, it may be understood that the shared data is substantially shared on the blockchain, and in this regard, the shared data is referred to as off-chain data.

### 2. DESCRIPTION OF THE RELATED ART

Blockchain is a data management technology, in which continuously increasing data are recorded within blocks of a specific unit and each blockchain node constituting a peer-to-peer network manages blocks as a data structure in the form of a chain. Blockchain can ensure the integrity and security of transactions through a consensus process, in which all blockchain nodes belonging to the network verify and record all transactions.

Data recorded within the blockchain is referred to as on-chain data, and data managed on the basis of blockchain technology but not recorded within the blockchain is referred to as off-chain data. Each block constituting the blockchain is also limited in size, and since the blockchain itself is an expensive resource, not all data that must be reliably managed can be recorded on the blockchain. That is, in response to a request for data access to the blockchain, there is a limit in storing all data as on-chain data on the blockchain.

There may be a demand for the sharing of off-chain data described above. For example, when the off-chain data stored within the storage node of the first internal network, in which packet transmission and reception are selectively blocked by security technology, is shared with the second internal network by the owner of the off-chain data, the off-chain data should be transferred to the storage node of the second internal network. At this time, the first internal network side should set the packet transmission and reception allowance for the second internal network. When sharing is possible only by setting the packet transmission and reception in this way, the management burden is increased, and an unexpected risk may occur in terms of security.

### SUMMARY

The technical problem to be achieved through some embodiments of the present invention is to provide a system and method for sharing off-chain data between different storage nodes.

Another technical problem to be achieved through some embodiments of the present invention is to provide a system and method for minimizing security risk in sharing off-chain data between different storage nodes.

Another technical problem to be achieved through some embodiments of the present invention is to provide, in sharing the off-chain data between different storage nodes, a system and method not requiring prior procedures such as performing a registration procedure for a sharing target storage node or a sharing target organization.

Another technical problem to be achieved through some embodiments of the present invention is to provide a system and method securing the reliability of each occurrence of data sharing by accurately notarizing the history of data sharing between different storage nodes and recording the history in the blockchain.

According to an aspect of the present disclosure, there is provided an off-chain data sharing system comprising a first storage node for storing off-chain data, a blockchain node for storing a ledger that records permission information of the off-chain data and a data stream hub (DSH) for relaying data transmission and reception between the first storage node and a second storage node requesting the off-chain data by referring to the permission information.

According to an embodiment, the data stream hub may relay the data transmission and reception only when there is a request for the off-chain data by the second storage node.

According to an embodiment, the data stream hub may be a node included in a blockchain network, to which the blockchain node belongs, and accesses the permission information through a DSH-node, which is a node subordinate to the data stream hub.

According to an embodiment, the data stream hub may be a node included in a blockchain network, to which the blockchain node belongs, and for distributed storing (i.e. storing in a distributed manner) the ledger.

According to an embodiment, the blockchain node may be a node subordinate to the first storage node, and for registering a transaction for off-chain data stored within the first storage node in the ledger.

According to an embodiment, the first storage node may be arranged within a secure network where connection to a device outside a secure network is blocked except for the data stream hub. The first storage node may be arranged within a secure network of a first organization, the second storage node may be arranged within a secure network of a second organization different from the first organization, the data stream hub may be arranged external to a secure network of the first organization, and arranged external to a secure network of the second organization.

According to an embodiment, the data stream hub may receive a request for off-chain data stored within the first storage node from the second storage node, and check whether the second storage node has a permission for the off-chain data by referring to the permission information. The second storage node may not have information about network address of the first storage node. Further, the data stream hub may be a node included within a blockchain network, to which the blockchain node belongs, and accesses the permission information through a DSH-node, which is a node subordinate to the data stream hub, and when the second storage node is confirmed to have a permission for the off-chain data, performs a first operation of requesting the off-chain data from the first storage node, a second operation of receiving the off-chain data from the first storage node, and a third operation of transmitting the off-chain data to the second storage node, and registers at least one transaction of the first operation, the second operation and the third operation in the ledger using the DSH-node. Further, the data stream hub may register, transaction of the first operation, transaction of the second operation and transaction of the third operation, on the ledger, using the DSH-node.

Further, the received request may include a signature generated using a secret key of the organization, the data stream hub may store a public key of an organization, to which the second storage node belongs, and authenticate a signature of the received request using a public key of an organization, to which the second storage node belongs, and when the signature fails authentication, transmit a failure message to the second storage node. The data stream hub may further store network address information of an organization, to which the second storage node belongs, and compare originating address information of the received request with the network address information to identify an organization, to which the second storage node belongs.

According to an embodiment, the data stream hub may receive off-chain data encrypted using a secret key of the organization of the first storage node, decrypt the off-chain data using a public key of the organization of the first storage node, and encrypt off-chain data using a public key of the organization of the second storage node, and transmit the encrypted off-chain data.

According to an embodiment, when an encrypted off-chain data encrypted using a secret key of the organization of the first storage node, is received from the first storage node, the data stream hub may forward the received encrypted off-chain data to the second storage node, and transmit an encrypted public key of the organization of the first storage node, which is encrypted using a secret key of the data stream hub.

According to an embodiment, the data stream hub may provide a public key of the second storage node to the first storage node, receive off-chain data encrypted by a public key of the second storage node from the first storage node, and transmit the encrypted off-chain data to the second storage node.

According to another aspect of the present disclosure, there is provided an off-chain data sharing method performed by a computing device comprising receiving a request for transmission of off-chain data stored within a first storage node from a second storage node, querying whether a transaction that the second storage node has the off-chain data permission exists in a ledger, in which permission information of the off-chain data is distributed and stored through the blockchain and requesting the off-chain data to the first storage node and receiving it when it is confirmed that the second storage node has the off-chain data permission as a result of the querying, and delivering the received off-chain data to the second storage node.

According to an embodiment, the first storage node may record a transaction sharing the off-chain data to the second storage node through a blockchain node subordinate to the first storage node in the ledger, the computing device may access the ledger through a blockchain node subordinate to the computing device.

According to still another aspect of the present disclosure, there is provided an off-chain data sharing system comprising a blockchain node for storing a ledger that records permission information of off-chain data, first storage nodes for distributed storing a chunk of the off-chain data and a first data stream hub arranged within a secure network such as the first storage nodes and for determining whether to transmit the off-chain data to a second data stream hub requesting the off-chain data by referring to the permission information. The second data stream hub may be arranged external to the secure network.

According to an embodiment, the first storage nodes may comprise a first storage node A and a first storage node B for receiving and storing original off-chain data from a client arranged within a secure network, such as the first storage nodes. Further, the first storage node A may request a public key of the first storage node B to the first data stream hub, and use the number of public keys received according to the request to chunk the original off-chain data.

According to an embodiment, the first storage node A, may store a chunking map indicating the result of the chunking. The chunking map may include an array of each public key of storage node storing each chunk. Further, the first data stream hub may receive the chunking map from the first storage node A, when the first data stream hub determines transmitting the off-chain data to the second data stream hub, construct the off-chain data using chunks of the off-chain data which is collected using the chunking map.

According to an embodiment, the blockchain node may be a node subordinate to each first storage node and may register a transaction for off-chain data stored in the first storage node in the ledger.

According to an embodiment, the secure network may be an internal network of a first organization, the second data stream hub may be located in an internal network of a secure network of a second organization different from the first organization. The secure network may exceptionally allow data transmission and reception between the first data stream hub and the second data stream hub.

According to an embodiment, the off-chain data sharing system may further comprise second storage nodes configured to store in a distributive manner chunked (i.e., partitioned) the off-chain data, the second storage nodes may comprise a second storage node A and second storage node B having a sharing permission of the off-chain data, the second data stream hub may receive the off-chain data from the first data stream hub and transmit it to the second storage node A. The second storage node A, upon receiving the off-chain data from the second data stream hub, may chunk the off-chain data, and then store the different chunks throughout second storage nodes A and B via the second data stream hub.

The technical problems of the present invention are not limited to the technical problems mentioned above, and other technical problems not mentioned will be clearly understood by those skilled in the art from the following description.

### BRIEF DESCRIPTION OF THE DRAWINGS

FIGS. 1 to 3 are block diagrams of an off-chain data sharing system according to an embodiment of the present invention.

FIGS. 4a to 4g are diagrams for describing an off-chain data sharing system and method described in conjunction with FIGS. 1 to 3.

FIG. 5 is a diagram for describing an off-chain data sharing system according to another embodiment of the present invention.

FIG. 6 is a diagram for describing a block chain network configuration according to the off-chain data sharing system described in conjunction with FIG. 5.

FIG. 7 is a diagram for describing a modified configuration of the off-chain data sharing system described in conjunction with FIG. 5.

FIG. 8 is a hardware block diagram of a data stream hub according to another embodiment of the present invention.

FIG. 9 is a flowchart of an off-chain data sharing method according to another embodiment of the present invention.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present invention, when it is determined that the detailed description of the related well-known configuration or function may obscure the gist of the present invention, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the invention. In this specification, the singular also includes the plural unless specifically stated otherwise in the phrase.

In addition, in describing the component of this invention, terms, such as first, second, A, B, (a), (b), can be used. These terms are only for distinguishing the components from other components, and the nature or order of the components is not limited by the terms. When a component is described as being “connected,” “coupled” or “contacted” to another component, that component may be directly connected to or contacted with that other component, but it should be understood that another component also may be “connected,” “coupled” or “contacted” between each component.

Hereinafter, some embodiments of the present invention will be described in detail with reference to the accompanying drawings.

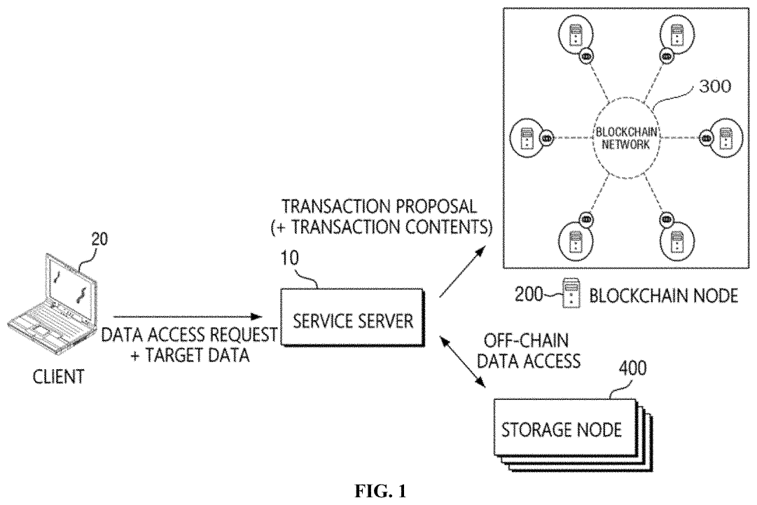

FIG. 1 is an exemplary block diagram illustrating an off-chain data sharing system according to an embodiment of the present invention.

As shown in FIG. 1, the off-chain data sharing system according to the present embodiment includes one or more blockchain nodes 200, one or more storage nodes 400, and a service server 10 constituting the blockchain network 300.

Blockchain node 200 is a node that constitutes a blockchain network having the peer-to-peer (P2P) structure and operates according to the blockchain protocol. Each blockchain node 200 can manage a ledger. In some embodiments, the ledger may include a blockchain, in which transaction data is recorded, and a state database (DB), in which state records (e.g., state values corresponding to state keys) are stored. Further, the transaction data may include a state record associated with the transaction. The blockchain node 200 can share various smart contracts and transaction data through the blockchain, and can ensure the integrity and security of transactions through a consensus process. The data recorded within the blockchain is referred to as on-chain data.

The storage node 400 is a device that stores off-chain data. The life cycle of the off-chain data is recorded as the on-chain data without missing. For example, at least one of CRUD (Create, Read, Update, Delete) history of the off-chain data, granting access permission of the off-chain data, changing previously granted access permission, withdrawing previously granted access permission, matter related to sharing of the off-chain data, request to provide shared off-chain data, off-chain data transmitted from the source storage node to the data stream hub, and off-chain data transmitted from the data stream hub to the target storage node is recorded as the on-chain data.

The service server 10 may receive a data access request, in which the target data is designated, from the client 20, read from the storage node 400 storing the target data as off-chain data, and then provide it to the client 20. Further, the service server 10 may provide a transaction proposal to the blockchain node 200 so that the processing history for the request for providing the target data to the client 20 can be additionally recorded as a transaction within the ledger, which is distributed and stored through the blockchain network.

The transaction proposal includes a progress state according to the sharing of the off-chain data and permission information for the off-chain data. The transaction contents may mean execution parameters of a smart contract.

The blockchain node 200 may receive the transaction proposal and execute a smart contract. The blockchain node 200 does not immediately update the ledger upon receipt of the transaction proposal, but may evaluate the transaction contents of the transaction proposal in light of the logic of the smart contract and the contents of the ledger stored by the blockchain node 200, and generate a smart contract execution result reflecting the evaluation result.

In some embodiments, the blockchain node 200 may refer to off-chain data stored in the storage node 400 in the process of executing the smart contract. For example, the completion of the normal storage of the off-chain data may be referred to during the execution of the smart contract.

The blockchain node 200 transmits the execution result of the smart contract and the endorsement of the blockchain node 200 to the service server 10 as a reply to the transaction proposal. The service server 10 aggregates the transaction proposal replies received from each blockchain node 200 and determines whether the consensus determination for the transaction proposal transmitted by the service server 10 is possible. The service server 10 may perform the consensus determination according to a predefined endorsement policy.

The service server 10 transmits a transaction request to the blockchain node 200 to add the transaction contents of the transaction proposal to the ledger as a new transaction when it is determined that the consensus determination for the transaction proposal is possible. For example, when the protocol of the blockchain is a Hyperledger fabric, the transaction request will be transmitted to the node in charge of the ordering service among the blockchain nodes 200. The node in charge of ordering service aggregates a transaction request to create a block, delivers the created block to all the storage nodes (committing peers), and each storage node checks whether each of all transactions in the delivered block complies with the endorsement policy, and when there is no problem, additionally connects the block to the existing blockchain.

As described, the service server 10 receives the off-chain data access request of the client 20 to provide the off-chain data, and records the history in the ledger of the blockchain without missing, thereby all the lifecycle of the off-chain data being recorded within the blockchain.

Although FIG. 1 illustrates that the service server 10 is implemented as a single computing device as an example, the first function of the service server 10 may be implemented in the first computing device, and the second function may be implemented in the second computing device.

Meanwhile, the client 20, the service server 10, and the storage node 400 of the off-chain data sharing system shown in FIG. 1 may be arranged within a secure network protected by security technology. Further, some nodes 200 constituting the blockchain network 300 may also be located within the secure network.

Assuming that the secure network is protected by a firewall that selectively allows the transmitting and receiving of packets, when the off-chain data requested by the client 20 is stored within an external storage node arranged external to the secure network as a storage node of another organization, in order to transmit a message requesting the off-chain data, a procedure of registering address information of the external storage node in the firewall should be performed. This pre-registration procedure causes inconvenience in many ways.

For example, in order to share specific off-chain data to an external storage node or to receive specific off-chain data from an external storage node, network address information of the external storage node should first be registered in the firewall. When the network address information of the external storage node has to be registered in the firewall first, sharing off-chain data with the storage node outside the secure network becomes very inconvenient.

In order to solve this problem, in some embodiments of the present invention, data transmission and reception between storage nodes belonging to different internal networks all occur via a data stream hub. For example, when a storage node of a first organization having a first secure network intends to receive off-chain data stored within a storage node of a second organization having a second secure network, the storage node of the first organization transmits a data requesting message to the data stream hub (DSH) and not the storage node of the second organization.

In some embodiments, the data stream hub may not be included in any organization. That is, from the perspective of each organization, the data stream hub may be a computing device arranged external to the internal network of the organization. However, due to the importance of the function, the data stream hub may be connected to a secure network protected by network security technology.

In this case, when the storage node only stores information for accessing the data stream hub, data transmission and reception for sharing off-chain data with the counterpart storage node is possible even when the information for accessing the counterpart storage node is not known. That is, when only the network address of the data stream hub is set as a target address for allowing of transmission and reception in the firewall for operating the secure network, there will be no problem in transmitting and receiving data for sharing off-chain data.

The data stream hub does not unconditionally allow data transmission and reception between a source storage node storing the sharing target off-chain data and a target storage node receiving the sharing target off-chain data. The data stream hub directly or indirectly accesses a blockchain storing a ledger that records the permission information of the sharing target off-chain data, and refers to the permission information of the sharing target off-chain data, and selectively relays transmission and reception of the sharing target off-chain data.

That is, the data stream hub verifies whether the target storage node has the permission to the sharing target off-chain data through the permission information recorded within the blockchain, and when the target storage node has the permission for the sharing target off-chain data, relays transmission and reception of the sharing target off-chain data.

The data stream hub does not itself transmit off-chain data to a specific storage node. That is, the data stream hub relays transmission and reception of off-chain data only when there is a request from the storage node.

As already described, all history regarding recording and sharing, etc. of off-chain data is recorded as a transaction in the ledger of the blockchain, and the data stream hub can also directly or indirectly access the ledger of the blockchain, as a result, it will be understood that the sharing of the off-chain data is controlled according to the permission information described in the ledger of the blockchain. That is, the integrity of the sharing of the off-chain data can be secured by the reliability of the blockchain technology.

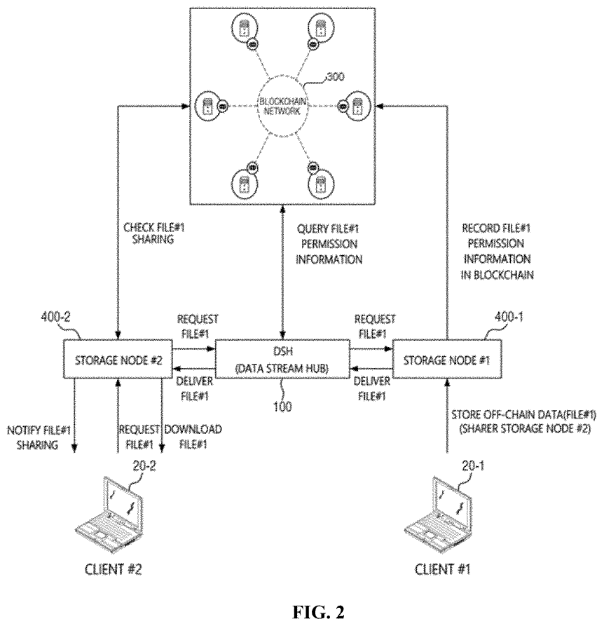

Hereinafter, it will be described in more detail with reference to FIG. 2. FIG. 2 is a diagram for describing an off-chain data sharing system according to the present embodiment, assuming an exemplary situation, in which the second storage node 400-2 requests file #1 from the first storage node 400-1.

In FIG. 1, it has been described that the client 20 requests access to off-chain data through the service server 10. However, a storage node at least partially including the function of the service server 10 of FIG. 1 may be provided. In this case, the client 20 may transmit a request to access the off-chain data directly to the storage node.

That is, the client 20 may transmit an access request for off-chain data to the service server 10 of FIG. 1, and the client 20 may transmit the access request to the storage node at least partially including the function of the service server.

For convenience of understanding, the off-chain data, which is the sharing target, is referred to as a first file (FILE #1). The first file is uploaded from the first client 20-1 to the first storage node 400-1. At this time, the first client 20-1 may transmit information indicating that the sharing target is the second storage node 400-2 as the sharing information of the first file from the first storage node 400-1. In some embodiments, the sharing target may be designated as a specific organization, not a specific storage node. In this case, all storage nodes belonging to the specific organization may access the first file.

When the storage of the first file is successfully completed, the first storage node 400-1 may transmit a transaction proposal to the blockchain network 300 so that a transaction indicating that the first file has been newly registered is recorded within a ledger. As described later, the first storage node 400-1 may have a blockchain node subordinate to the first storage node 400-1. That is, the first storage node 400-1 may transmit the transaction proposal to the blockchain network through the subordinate blockchain node.

However, according to some embodiments, the first storage node 400-1 itself may be a blockchain node belonging to the blockchain network. In this case, the first storage node 400-1 may include a blockchain processing module (not shown) that stores in a distributed manner the ledger and executes a chain code.

When a transaction indicating that the first file, of which sharing target (i.e., recipient) is designated as the second storage node 400-2, has been newly registered is added to the ledger, the transaction is also be added to the ledger stored by the blockchain node of the organization, to which the second storage node 400-2 belongs, based on the blockchain technology. That is, the second storage node 400-2 confirms the new registration of the first file through the blockchain node subordinate to the second storage node 400-2.

In order to monitor the fact that the file, in which the storage node connected to the blockchain node is designated as the sharing target, has been newly registered, each blockchain node may execute the chain code to notify the client that the file, in which the storage node connected to the blockchain node is designated as the sharing target, has been newly registered. Through the execution of the chain code, the second client 20-2 outputs a new shared file notification message, and in response to the notification message, the user of the second client 20-2 may select the request to download the first file.

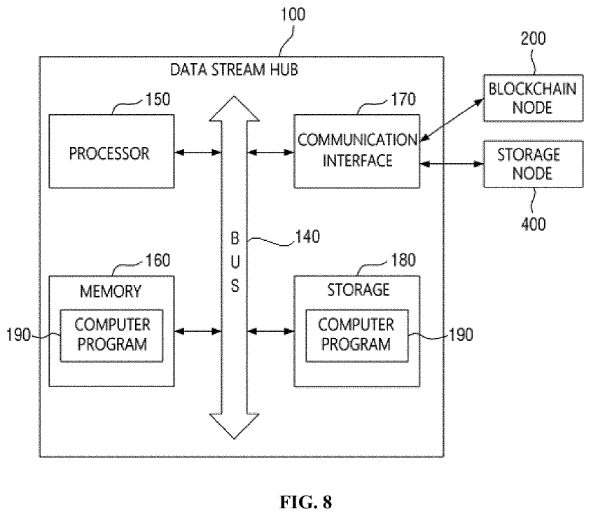

The second storage node 400-2 receives the download request and transmits a request for providing a first file to the data stream hub (hereinafter, referred to as ‘DSH’) 100. DSH 100 may also be referred to as a computing device 100 which will later be discussed in conjunction with FIG. 8.

The DSH 100 receives the request to provide the first file and queries whether the second storage node 400-2 is registered as a sharing target of the first file in the blockchain network. When the second storage node 400-2 is not registered as the sharing target of the first file in the permission information of the ledger that is distributed and stored within the blockchain network, the DSH 100 may transmit a reply message informing that there is no access permission to the second storage node 400-2.

The DSH 100 may access the ledger through a blockchain node subordinate to the DSH 100. Further, according to some embodiments, the DSH 100 itself may be a blockchain node belonging to the blockchain network. In this case, the DSH 100 may include a blockchain processing module (not shown) for distributed storing of the ledger and executing the chain code.

When the second storage node 400-2 is registered as the sharing target of the first file in the permission information of the ledger distributed and stored within the blockchain network, the DSH 100 may request the first storage node 400-1 to provide the first file and receive the first file in response thereto. Further, the DSH 100 transmits the first file to the second storage node 400-2.

When the second storage node 400-2 finishes storing the first file, the second client 20-2 can download the first file. In some embodiments, the second storage node 400-2 may provide a fast download of a streaming method by delivering the data packet of the first file from the DSH 100 directly to the second client 20-2.

In some embodiments, at least some of the new registration of the first file, the new registration confirmation of the second storage node 400-2, the fact of the first file request of the second storage node 400-2 for the DSH 100 and whether the verification passes therefor, the fact of the first file request of the DSH 100 for the first storage node 400-1, the first file provision of the first storage node 400-1 for the DSH 100, the first file provision of the DSH 100 for the second storage node 400-2 and the download provision completion of the second storage node 400-2 may be transacted and recorded within the ledger.

For example, all of the new registration of the first file, the new registration confirmation of the second storage node 400-2, the fact of the first file request of the second storage node 400-2 for the DSH 100 and whether the verification passes therefor, the fact of the first file request of the DSH 100 for the first storage node 400-1, the first file provision of the first storage node 400-1 for the DSH 100, the first file provision of the DSH 100 for the second storage node 400-2 and the download provision completion of the second storage node 400-2 may be transacted and recorded within the ledger.

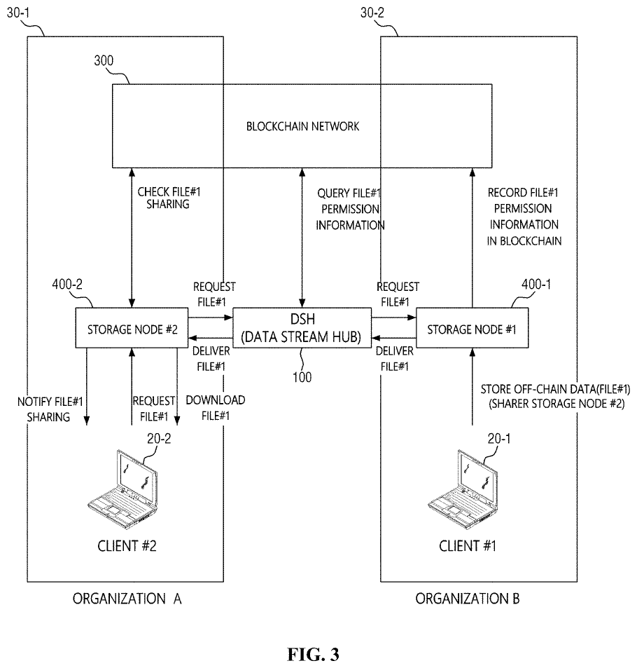

In some embodiments, the first storage node 400-1 and the second storage node 400-2 may belong to different organizations. For example, as shown in FIG. 3, the first storage node 400-1 may be arranged within the secure network 30-2 of the organization B, and the second storage node 400-2 may be within the secure network 30-1 of the organization A.

One or more first blockchain nodes (not shown) may be further connected to the secure network 30-1 of the organization A, and one or more second blockchain nodes (not shown) may be further connected to the secure network 30-2 of the organization B. The one or more first blockchain nodes and the one or more second blockchain nodes are blockchain nodes belonging to the blockchain network 300.

The DSH 10 may be arranged external to the secure network 30-1 of the organization A, while being arranged external to the secure network 30-2 of the organization B.

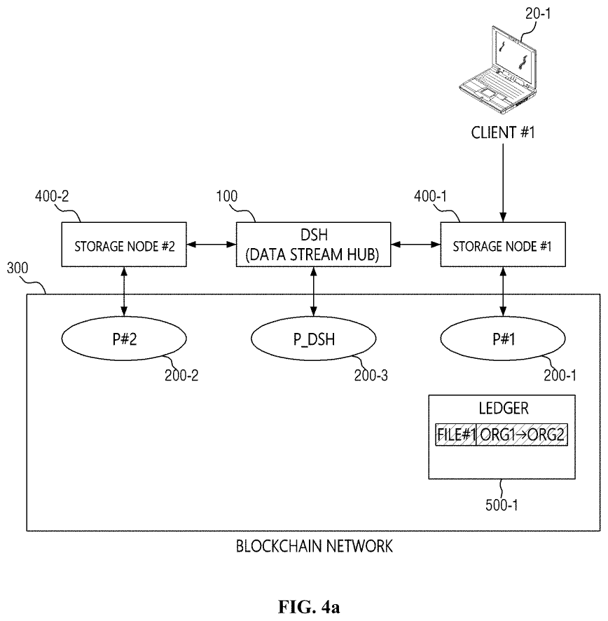

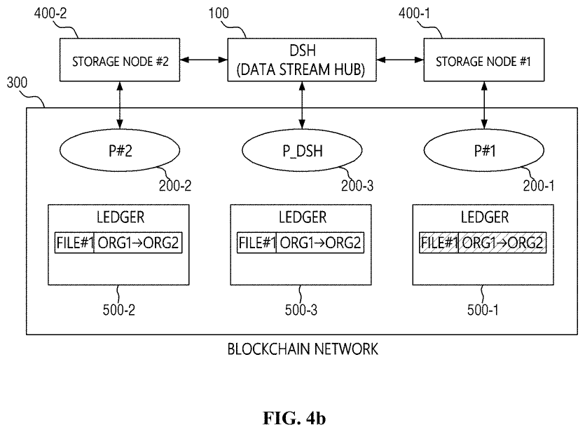

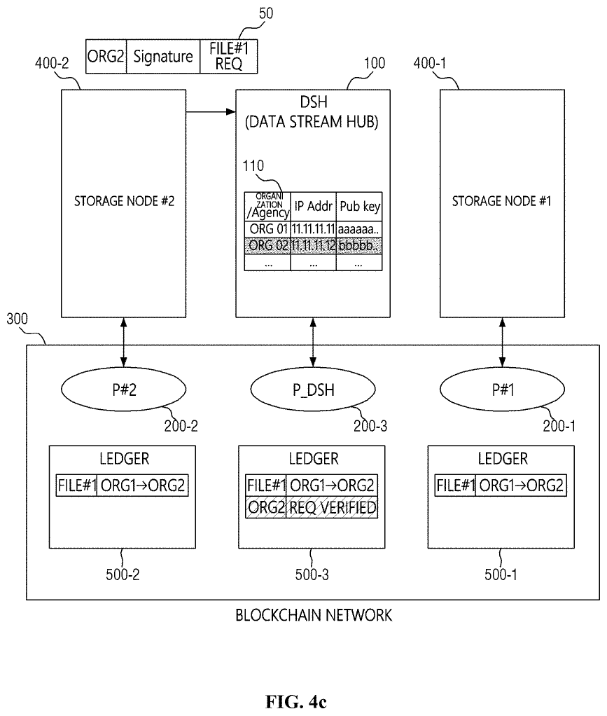

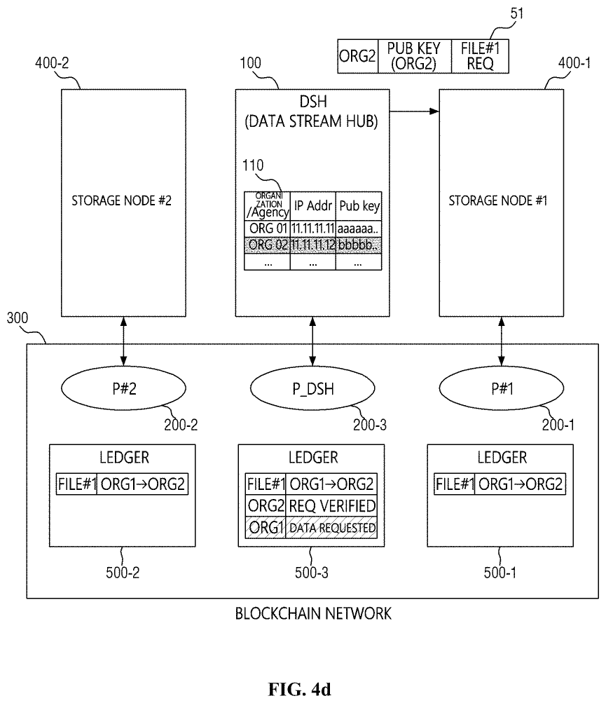

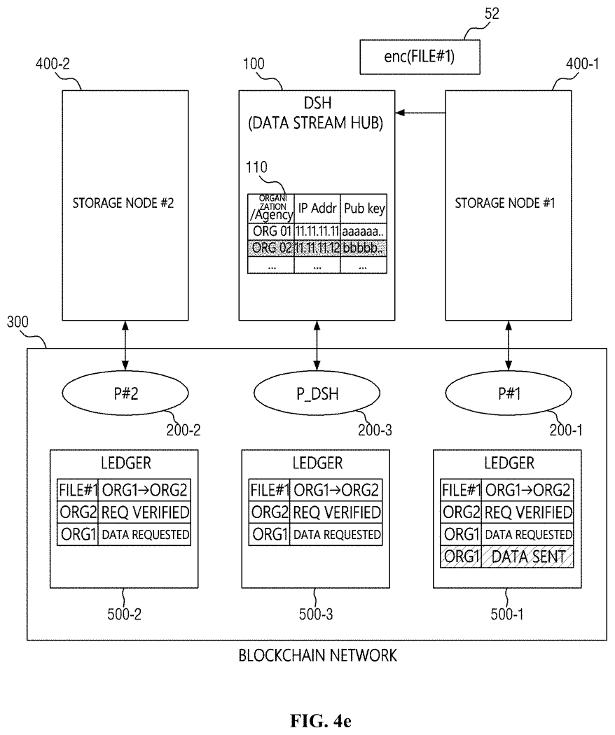

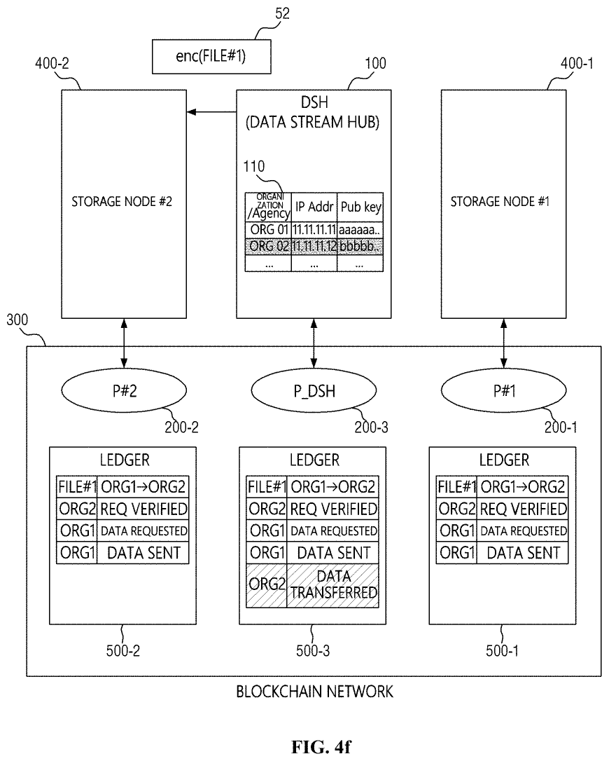

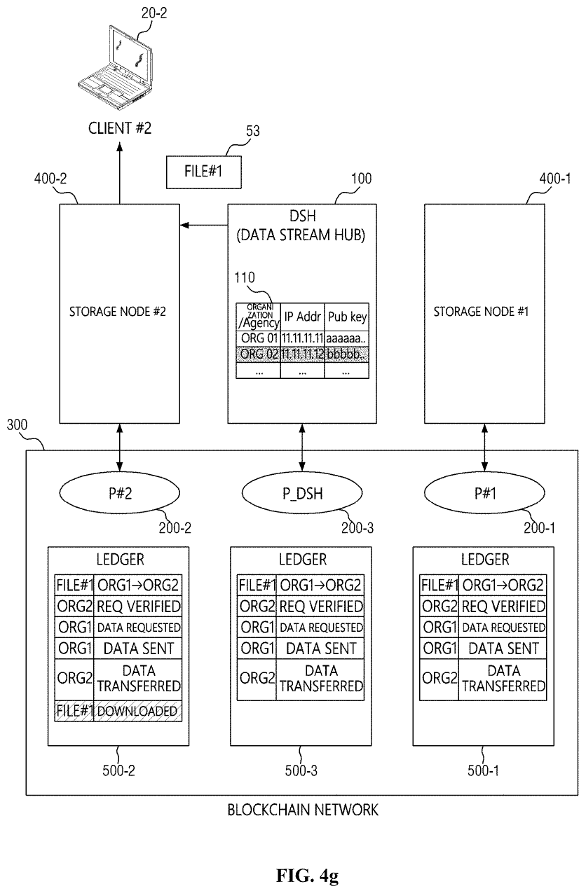

Hereinafter, the process of sharing the first file in the ledger distributed and stored within the blockchain network is transacted and recorded, and the process of sharing the first file with reference to the record of the ledger will be described with reference to FIGS. 4a to 4g. The first storage node 400-1 (or the organization, to which the first storage node belongs) is illustrated as ‘ORG1’ in FIGS. 4a to 4g, and the second storage node 400-2 (or the organization, to which the second storage node belongs) is illustrated as ‘ORG2’ in FIGS. 4a to 4g.

Referring to FIG. 4a, the first client 20-1 uploads the first file to the first storage node 400-1, and the first storage node 400-1 records a new transaction indicating that ‘the first file has been newly registered, and the first storage node 400-1 shared it with the second storage node 400-2’ in the ledger 500-1 through the blockchain node 200-1 subordinate to the first storage node 400-1. Hereinafter, in FIG. 4a to FIG. 4g, each new transaction is designated by as hatching.

In some embodiments, the first storage node 400-1 confirms that the upload of the first file is successfully completed, and then may record anew transaction indicating that ‘the first file has been newly registered, and the first storage node 400-1 shared it with the second storage node 400-2’ in the ledger 500-1. In this case, the integrity of the new transaction recorded within the ledger 500-1 may be secured.

The new transaction, as shown in FIG. 4b, will be also recorded within the ledger 500-2 stored within the blockchain node 200-2 subordinate to the second storage node 400-2 and the ledger 500-3 stored within the blockchain node 200-3 subordinate to DSH 100.

Referring to FIG. 4c, the second storage node 400-2 may transmit the request message 50 containing the first file request to the DSH 100. The request message 50 may include an identifier (ORG2) of the second storage node 400-2, information (FILE #1) indicating the requesting target off-chain data, and a signature.

The DSH 100 may verify the request message 50 using the signature and the sender network address (e.g., IP address) of the request message 50. The DSH 100 may refer to the stored storage node information 110 during the verification.

The DSH 100 obtains the network address of the self-stored second storage node from the identifier ORG2 of the second storage node 400-2 included in the request message 50, and may perform the first verification by determining whether the obtained network address corresponds to the sender network address of the request message 50.

Further, the DSH 100 may decrypt the signature using a public key of the self-stored second storage node, and perform a second verification using the decrypted signature. That is, the second storage node 400-2 may generate the signature by encrypting data previously shared with the DSH 100 using a private key of the second storage node 400-2.

When the request message 50 passes the first verification and the second verification, the DSH 100 may refer to the permission information of the ledger 500-3 to perform a third verification to determine whether the second storage node 400-2 has access permission to the first file. As illustrated in FIG. 4c, since a transaction indicating that the first file is shared with the second storage node 400-2 is recorded in the ledger 500-3 stored in the node 200-3 subordinate to the DSH 100, the third verification will pass. The DSH 100 may record a new transaction in the ledger 500-3 indicating that the request message 50 has passed verification.

Hereinafter, in this specification, ‘node subordinate to first device’ may be understood to mean a blockchain node connected in a one-to-one relationship with a first device, as opposed to just a blockchain node.

Referring to FIG. 4d, since the request message 50 has passed the verification, the DSH 100 may transmit a message 51 requesting the first storage node 400-1 to provide the first file, and record a new transaction (ORG1|DATA REQUESTED) indicating the fact of transmission of the message 51 in the ledger 500-3.

The DSH 100 may include the public key of the second storage node 400-2 in the message 51. The DSH 100 may store the public key of the second storage node 400-2 previously registered from the second storage node 400-2. The public key of the second storage node 400-2 will be used as the encryption key of the first file.

As shown in FIG. 4e, the two transactions newly recorded by the DSH 100 are also recorded in ledgers 500-1 stored in the subordinate blockchain nodes 200-1 of the first storage node 400-1 and the ledger 500-2 stored in the subordinate blockchain node 200-2 of the second storage node 400-2.

In addition, the first storage node 400-1 encrypts the first file requested from the DSH 100 using the public key of the second storage node 400-2 included in the message 51, and transmits the encrypted first file 52 to the DSH 100. When the transmission of the encrypted first file to the DSH 100 is completed, such fact is recorded in the ledger 500-1 as a new transaction.

In some embodiments, DSH 100 may not include the public key of second storage node 400-2 in the message 51. In such a scenario, the first storage node 400-1 encrypts the first file requested from the DSH 10 with the secret key of the first storage node 400-1, and transmits the encrypted first file to the DSH 100.

Thereafter, the DSH 100 may decrypt the first file encrypted using the public key of the first storage node 400-1, and again encrypt the first file decrypted using the public key of the second storage node 400-2, and then transmit the encrypted first file to the second storage node 400-2. At this time, the second storage node 400-2 may decrypt the first file encrypted using the secret key of the second storage node 400-2. According to this embodiment, since the data received by the DSH 100 from the storage node #1 400-1 and the data transmitted to the storage node #2 400-2 will be completely different, the result has a security effect that makes it difficult to track the packet of the first file.

Alternatively, the DSH 100 may deliver the first file encrypted with the secret key of the first storage node 400-1 to the second storage node 400-2 as it is. At this time, the DSH 100 may provide the second storage node 400-2 with the public key of the first storage node 400-1 in an encrypted form. For example, the DSH 100 may provide the public key of the first storage node 400-1 encrypted with the secret key of the DSH to the second storage node 400-2.

As shown in FIG. 4f, the transaction newly recorded by the first storage node 400-1 will also be recorded in the ledger 500-3 stored in the subordinate blockchain node 200-3 of the DSH 100 and the ledger 500-2 stored in the subordinate blockchain node 200-2 of the second storage node 400-2.

The DSH 100 transmits the encrypted first file 52 received from the first storage node 400-1 to the second storage node 400-2, and when the transmission is completed, records such fact in the ledger 500-3.

As shown in FIG. 4g, the transaction newly recorded by the DSH 100 will also be recorded in the ledger 500-1 stored in the subordinate blockchain node 200-3 of the first storage node 400-1 and the ledger 500-3 stored in the subordinate blockchain node 200-3 of the second storage node 400-2.

When the reception of the encrypted first file 52 from the DSH 100 is completed, the second storage node 400-2 decrypts the encrypted first file 52 using the secret key of the second storage node 400-2 to obtain the first file 53. The second storage node 400-2 transmits the first file 53 to the client 20-2, and when the client 20-2 completes downloading the first file 53, a new transaction entry indicating that the first file has been downloaded is recorded in the ledger 500-2.

In the off-chain data sharing process described so far, since all of the processes are recorded on the blockchain, and since the permission information is required to be consulted prior to sharing the data, reliability and security can be achieved. In addition, since each storage node can share or receive off-chain data even when it does not know information about the counter storage node, limitations in operating a sharing system of off-chain data may disappear.

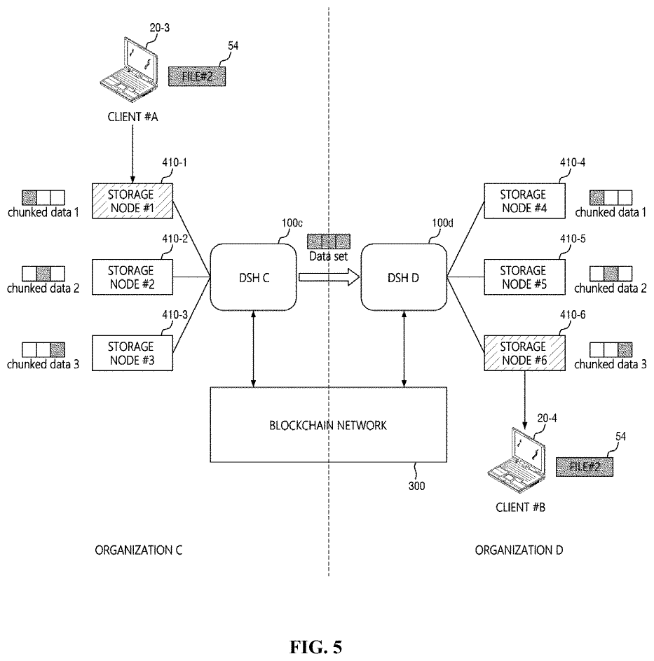

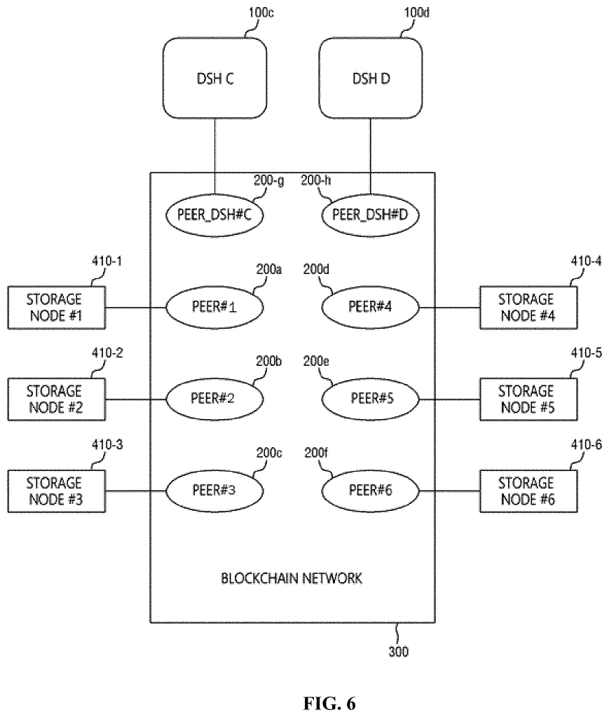

Hereinafter, an off-chain data sharing system according to another embodiment of the present invention will be described with reference to FIGS. 5 to 6.

In the embodiment described with reference to FIGS. 5 to 6, a DSH may be provided for each organization. In this case, access information of different DSHs is stored in each DSH. As the number of organizations connected to the blockchain network 300 increases, the number of storage nodes will increase accordingly.

Since the DSH 100 described with reference to FIGS. 2 to 4h can store information about each storage node, when the number of storage nodes increases, the DSH 100 may be subjected to excessive storage load or computational load. On the other hand, in the embodiment described with reference to FIGS. 5 to 6, since only the access information of other DSHs connected to each DSH needs to be stored, and the number of other DSHs will be much less than the number of storage nodes, the problem of excessive storage load or computation load applied to an individual DSH may be solved.

Referring to FIG. 5, the off-chain data sharing system according to the present embodiment may include DSH C 100c belonging to organization C, one or more storage nodes 410-1, 410-2, 410-3 belonging to organization C and one or more blockchain nodes (not shown) belonging to organization C and constituting the blockchain network 300.

It will be described assuming the situation that the client A 20-3 uploads the second file 54 to the storage node 1 410-1 and the sharing target of the second file 54 is designated as the storage node 6 410-6 belonging to the organization D.

When the upload of the second file 54 is completed, the storage node 1 410-1 may request the public key of the storage nodes connected to the DSH C 100c to the DSH C 100c. The storage node 1 410-1 may chunk the original off-chain data using the number of public keys received from the DSH C 100c according to the request. In the case shown in FIG. 5, the number of public keys is three, and therefore, the storage node 1 410-1 will divide the second file 54 into three chunks.

The storage node 1 410-1 may store a chunking map indicating the result of the chunking. The chunking map is data indicating the connection order for each chunk, and the structure and expression method of the data may be variously defined. For example, the chunking map may be a public key of storage nodes storing each chunk arranged in the order of each chunk. In this case, it can be understood that although the storage node 1 410-1 does not have the identification information of other storage nodes (storage node 2 and storage node 3) belonging to the same organization, the chunking map is constructed using a storage node identifier that can be understood by DSH C 100c by using the public key of each storage node as a kind of identifier.

The storage node 1 410-1 transmits each chunk and identification information (e.g., a public key of the storage node) of the storage node, in which the chunk is to be stored, to the DSH C 100c, and the DSH C 100c may store in a distributed manner (i.e., distributively store) each chunk in a storage node. That is, in the situation shown in FIG. 5, chunk 2 may be stored in storage node 2 410-2, chunk 3 may be stored in storage node 3 410-3, and chunk 1 may be stored in storage node 1 410-1.

In some embodiments, when each chunk is distributed and stored, two or more duplication factors are applied, and thus each chunk may be distributed and stored in two or more storage nodes. In this case, even when a specific storage node becomes inoperable, the chunk stored in the storage node is redundantly stored in another storage node, and as a result, damage to off-chain data may be prevented.

After the distributed storage of the second file 54 is completed, a new transaction indicating that the second file, of which sharing target (i.e., recipient) is storage node 6 410-6, has been newly registered and is recorded in the ledger (not shown) that is distributed and stored in the blockchain network 300 through the blockchain node subordinate to the storage node 1 401-1. The new transaction may include information indicating that the storage node owning the second file 54 is the storage node 1 410-1.

Referring to FIG. 6, each of the storage nodes 1 to 6 (410-1 to 410-6) has subordinate blockchain nodes 200a to 200f, respectively, DSH C 100c and DSH D 100d each also has subordinate blockchain nodes 200-g, 200-h, respectively. This means that storage nodes 1 to 6 410-1 to 410-6, DSH C 100c, and DSH D 100d can access the transactions recorded in the ledger. Therefore, the storage node 6 410-6 may also access the new transaction indicating that the second file 54, of which sharing target is storage node 6 401-6, has been newly registered.

The storage node 6 410-6 may transmit a message inquiring whether the second file 54 is downloaded to the client B 20-4, and may receive a download request in response. In this case, the storage node 6 410-6 transmits a second file providing request message to the DSH D 100d.

DSH D 100d may query the ledger, confirm that the organization having the second file 54 is the storage node 1 410-1 of organization C, and transmit a message to request DSH C 100c of organization C to provide the second file 54.

DSH C 100c may receive a message requesting the provision of a second file 54 from DSH D 100d, confirm that the storage node owning the second file 54 is storage node 1 410-1 in the ledger, and request the storage node 1 410-1 to provide the chunking map.

The DSH C 100c may receive the chunking map from the storage node 1 410-1, use the chunking map to collect chunks of the second file 54 distributed and stored throughout the storage nodes 1 to 3 410-1 to 410-3, and reassemble the collected chunks using the chunking map to restore the second file 54.

DSH C 100c then transmits second file 54 to DSH D 100d. When receiving the second file 54, the DSH D 100d delivers the second file 54 to the storage node 6 410-6, which has requested the provision of the second file 54. The storage node 6 410-6 may chunk the second file 54 in the same way as was previously done by storage node 410-1, and then distribute and store the chunks of the second file 54 within the storage nodes of organization D.

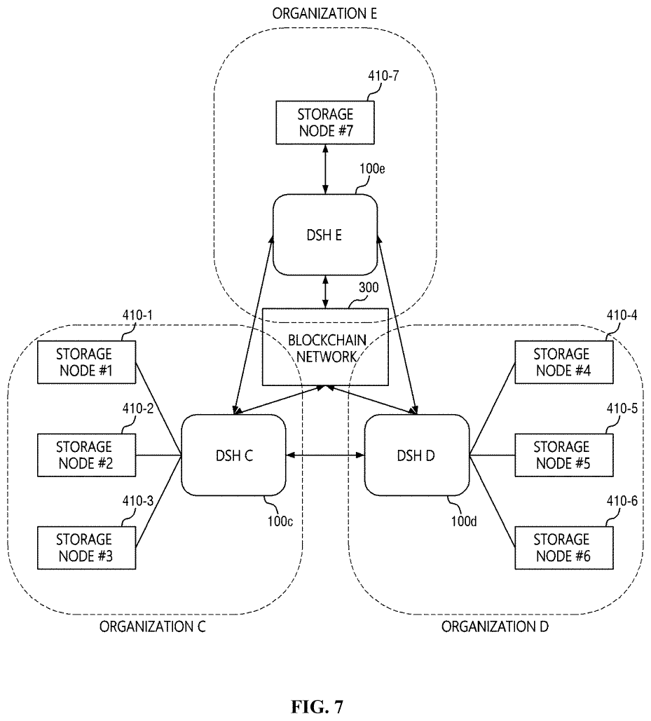

Although the off-chain data sharing system, in which two organizations are connected to each other, is described with reference to FIG. 5, an off-chain data sharing system, in which three (or more) organizations are connected to each other, is also configurable, as illustrated in FIG. 7.

Referring now to FIG. 7, FIG. 7 illustrates an off-chain data sharing system where three organizations are present. FIG. 7 is analogous to the arrangement of FIG. 5, except that a third organization called Organization E is also connected to blockchain network 300. As with the arrangements of FIGS. 5 and 6, Organization E of FIG. 7 includes its own DSH E 100e and includes a storage node 7 410-7. In a similar manner as that previously described in conjunction with FIGS. 5 and 6 above, files can be shared among clients of the 3 organizations C. D and E.

Hereinafter, an exemplary computing device 100 capable of implementing the data stream hubs described in various embodiments of the present invention will be described with reference to FIG. 8.

As shown in FIG. 8, the computing device 100 may include a memory 160 that loads a computer program 190 executed by one or more processors 150, a system bus 140, a communication interface 170 and a storage 180 for storing the computer program 190. In FIG. 8, only components related to the embodiment of the present invention are shown. Accordingly, it can be seen that those skilled in the art to which the present invention pertains may understand that other general-purpose components in addition to the components shown in FIG. 8 may be further included.

The processor 150 controls the overall operation of each component of the computing device 100. The processor 150 may be configured to include at least one of a central processing unit (CPU), a microprocessor unit (MPU), a micro controller unit (MCU), a graphics processing unit (GPU), or any type of processor well known in the art. Further, the processor 150 may perform operations on at least one application or program for executing a method/operation according to various embodiments of the present invention. The computing device 100 may include one or more processors.

The memory 160 stores various data, commands and/or information. The memory 160 may load one or more programs 190 from the storage 180 to execute methods/operations according to various embodiments of the present invention. An example of the memory 160 may be RAM, but is not limited thereto.

The bus 140 provides a communication function between components of the computing device 100. The bus 140 may be implemented as various types of buses, such as an address bus, a data bus, and a control bus.

The communication interface 170 supports wired and wireless Internet communication of the computing device 100. The communication interface 170 may support various communication methods other than Internet communication. To this end, the communication interface 170 may be configured to include a communication module well known in the technical field of the present invention. The communication interface 170 may connect one or more blockchain nodes 200 and one or more storage nodes 400.

The storage 180 may store one or more computer programs 190 in a manner that can survive a power outage (i.e., non-temporarily). The storage 180 may include a non-volatile memory such as a flash memory, a hard disk, a removable disk, or any type of computer-readable recording medium well known in the art.

The computer program 190 may include one or more instructions, in which methods/operations according to various embodiments of the present invention are implemented. When the computer program 190 is loaded into the memory 160, the processor 150 may perform the methods/operations according to various embodiments of the present invention by executing the one or more instructions.

For example, the computer program 190 may include an instruction of requesting to transmit off-chain data stored in the first storage node to the second storage node, and an instruction to query whether there is a transaction indicating that the second storage node has the off-chain data permission in the ledger, in which the permission information of the off-chain data is distributed and stored through the blockchain, and an instruction of requesting and receiving the off-chain data from the first storage node, and delivering the received off-chain data to the second storage node when it is confirmed that the second storage node has the off-chain data permission as a result of the inquiry.

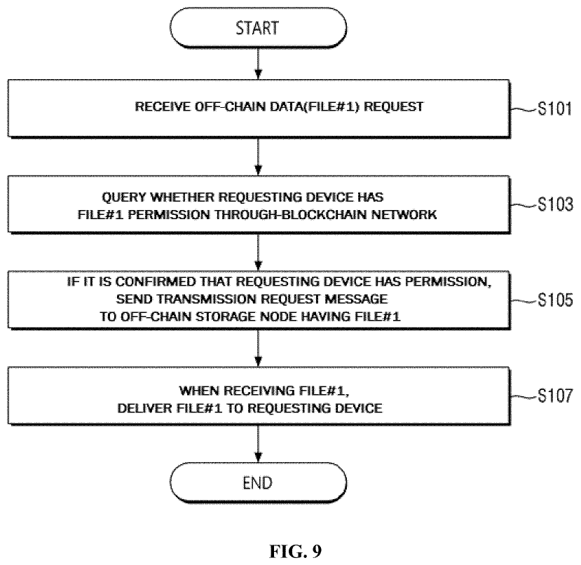

Hereinafter, an off-chain data sharing method according to another embodiment of the present invention will be described with reference to FIG. 9. The off-chain data sharing method according to this embodiment may be performed by a computing device, and can be performed by, for example, DSH 100 described with reference to FIGS. 2 to 4g, DSH C 100c, DSH D 100d and DSH E 100e described with reference to FIGS. 5 and 7. For the sake of understanding, operations overlapped with those described with reference to FIGS. 1 to 8 will be abbreviated or omitted. Although abbreviated or omitted, the technical idea described with reference to FIGS. 1 to 8 can be naturally applied to the off-chain data sharing method according to the present embodiment.

In step S101, a request for providing a first file that is off-chain data is received from the requesting device. The providing request may include identification information of the requesting device and identification information of the first file.

In step S103, in the ledger distributed and stored throughout the blockchain, a transaction, in which the requesting device is designated as the sharing target (i.e., recipient) of the first file, is queried. At this time, the ledger may be accessed through a blockchain node subordinate to the computing device performing step S103.

When the transaction, in which the requesting device is designated as the sharing target of the first file, is not queried, a failure reply will be transmitted to the providing request. Conversely, when the transaction, in which the requesting device is designated as the sharing target of the first file, is queried, the sharer (i.e., source) device according to the transaction is checked. The sharer device may be understood as a device storing the first file.

As already described, the requesting device and the sharer device may be located in different secure networks.

In step S105, the transmission request message of the first file is transmitted to the sharer device. Next, in step S107, when the first file is received from the sharer device, the first file is delivered to the requesting device.

The technical features of the present disclosure described with reference to FIGS. 1 to 9 so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as Internet and installed in the other computing device, thereby being used in the other computing device.

Although the operations are shown in a specific order in the drawings, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation. The scope of protection of the present invention should be interpreted by the following claims, and all technical ideas within the scope equivalent thereto should be construed as being included in the scope of the technical idea defined by the present disclosure.

What is claimed is:

1. An off-chain data sharing system comprising:
a first storage node to store off-chain data;
a second storage node to request the off-chain data;
a blockchain node to store a ledger that records permission information of the off-chain data; and
a data stream hub (DSH) to relay data transmission and reception between the first storage node and the second storage node by referring to the permission information.

2. The off-chain data sharing system of claim 1, wherein the data stream hub relays the data transmission and reception only when there is a request for the off-chain data from the second storage node.

3. The off-chain data sharing system of claim 1, wherein the data stream hub is a node included in a blockchain network, to which the blockchain node belongs, and accesses the permission information through a DSH-node, which is a node subordinate to the data stream hub.

4. The off-chain data sharing system of claim 1, wherein the data stream hub is a node included in a blockchain network, to which the blockchain node belongs, and to distributed-store the ledger.

5. The off-chain data sharing system of claim 1, wherein the blockchain node is a node subordinate to the first storage node, and to record a transaction of the off-chain data stored within the first storage node within the ledger.

6. The off-chain data sharing system of claim 1, wherein the first storage node is arranged within a first secure network where connection to a device outside the first secure network is blocked except for the data stream hub.

7. The off-chain data sharing system of claim 6, wherein the first storage node is arranged within the first secure network of a first organization;
the second storage node is arranged within a second secure network of a second organization different from the first organization; and
the data stream hub is arranged external to the first secure network of the first organization, and arranged external to the second secure network of the second organization.

8. The off-chain data sharing system of claim 1, wherein the data stream hub is configured to receive a request for the off-chain data stored in the first storage node from the second storage node, and to check whether the second storage node has a permission for the off-chain data by referring to the permission information.

9. The off-chain data sharing system of claim 8, wherein the second storage node is absent of information about network address of the first storage node.

10. The off-chain data sharing system of claim 8, wherein the data stream hub is a node included in a blockchain network, to which the blockchain node belongs, and the data stream hub is configured to access the permission information through a DSH-node, which is a node subordinate to the data stream hub; and
the second storage node is configured to be confirmed to have the permission for the off-chain data, to perform a first operation of requesting the off-chain data to the first storage node, a second operation of receiving the off-chain data from the first storage node, and a third operation of transmitting the off-chain data to the second storage node, and to record at least one transaction of the first operation, the second operation and the third operation in the ledger using the DSH-node.

11. The off-chain data sharing system of claim 8, wherein the received request includes a signature generated using a secret key of an organization to which the second storage node belongs; and
the data stream hub is configured to store a public key of the organization and to authenticate the signature of the received request using the public key of the organization, and to transmit a failure message to the second storage node when the signature fails authentication.

12. The off-chain data sharing system of claim 11, wherein the data stream hub is further configured to:
store network address information of the organization; and
compare originating address information of the received request with the stored network address information to check when the originating address information is matched with the stored network address information.

13. The off-chain data sharing system of claim 8, wherein the data stream hub is configured to:
provide a public key of the second storage node to the first storage node;
receive the off-chain data encrypted with the public key of the second storage node from the first storage node; and
transmit the encrypted off-chain data to the second storage node.

14. A method of sharing off-chain data using a computing device, the method comprising:
receiving a request for transmission of off-chain data stored in a first storage node from a second storage node;
querying whether a transaction that the second storage node has the off-chain data permission exists in a ledger, in which permission information of the off-chain data is distributed and stored through the blockchain;
requesting the off-chain data from the first storage node;
receiving the off-chain data when it is confirmed that the second storage node has the off-chain data permission as a result of the querying; and
delivering the received off-chain data to the second storage node.

15. The off-chain data sharing method of claim 14, wherein the first storage node records a transaction sharing the off-chain data with the second storage node through a blockchain node subordinate to the first storage node in the ledger; and
the computing device accesses the ledger through a blockchain node subordinate to the computing device.

16. An off-chain data sharing system comprising:
a blockchain node to store a ledger that records permission information of off-chain data;
first storage nodes for distributed storing chunks of the off-chain data;
a first data stream hub arranged within a secure network of the first storage nodes and to determine whether to transmit the off-chain data to a second data stream hub requesting the off-chain data by referring to the permission information; and
the second data stream hub arranged external to the secure network.

17. The off-chain data sharing system of claim 16, wherein the first storage nodes comprise a first storage node A and a first storage node B to receive and store original off-chain data from a client arranged within the secure network; and
the first storage node A to request at least one public key of the first storage node B from the first data stream hub, and to use the at least one public key received according to the request to chunk the original off-chain data.

18. The off-chain data sharing system of claim 16, wherein the blockchain node is a node subordinate to each of the first storage nodes, and the blockchain node is configured to record a transaction for the off-chain data stored in the first storage node in the ledger.

19. The off-chain data sharing system of claim 16, wherein the secure network is an internal network of a first organization;
the second data stream hub is arranged within an internal network of a secure network of a second organization different from the first organization; and
the secure network exceptionally allows data transmission and reception between the first data stream hub and the second data stream hub.

20. The off-chain data sharing system of claim 16, wherein the off-chain data sharing system further comprises second storage nodes configured to distributed store the second data stream hub and a chunk of the off-chain data;
the second storage nodes comprise a second storage node A and second storage node B having a sharing permission of the off-chain data;
the second data stream hub receives the off-chain data from the first data stream hub and transmits the off-chain data to the second storage node A; and
the second storage node A, upon receiving the off-chain data from the second data stream hub, chunks the off-chain data, and stores in a distributed way each chunk in the second storage node B through the second data stream hub.
